(19) United States
(12) Patent Application Publication
(10) Pub. No.: US 2006/0077929 A1
(43) Pub. Date: Apr. 13, 2006

(54) Apparatus and method for receiving LLC packet data of mobile communications system

(75) Inventor: Eun-Young Park, Gyeonggi-Do (KR)

Correspondence Address: JONATHAN Y. KANG, ESQ.;LEE & HONG P.C., 14th Floor, 801 S. Figueroa Street, Los Angeles, CA, 90017-5554, US

(73) Assignee: LG Electronics Inc.

(21) Appl. No.: 11/245,504

(22) Filed: Oct. 7, 2005

(30) Foreign Application Priority Data
Oct. 8, 2004 (KR) 2004-80562

(51) Int. Cl. H04J 3/22

(52) U.S. Cl. 370/329; 370/471

(57) ABSTRACT

A method for receiving Logical Link Control (LLC) packet data of a mobile communications system comprising: detecting missed data using a frame number of received data; checking whether the number of the missed data having detected is less than a reference value; and ignoring the corresponding missed data when it is checked that the number of the missed data is less than the reference value, and transmitting currently-received data in real-time, whereby even if audio or real-time data partially contains an error and is missed in the air, the real-time transmission is ensured so as to allow a user to enjoy voice chatting or real-time videos more conveniently.

### CROSS REFERENCE TO RELATED APPLICATIONS

Pursuant to 35 U.S.C. § 119(a), this application claims the benefit of earlier filing date and right of priority to Korean Application No. 10-2004-80562, filed on Oct. 8, 2004, the contents of which are hereby incorporated by reference herein in their entirety.

### BACKGROUND OF THE INVENTION

1. Field of the Invention

The present invention relates to transmitting and receiving packet data of a mobile communications system, and particularly, to an apparatus and method for receiving packet data efficiently in a Logical Link Control (LLC) acknowledged transmission mode of a General Packet Radio Service (GPRS) network.

2. Background of the Related Art

In general, General Packet Radio Service (GPRS) is a 2.5 generation mobile phone technology which is being provided in Europe on the basis of a Global System for Mobile Communication (GSM). The GPRS provides a packet data service through a radio communications system.

The packet data provided by the GPRS, which is a type of real-time traffic, must be mainly transmitted intermittently and instantaneously as compared with circuit switched data, and must be correctly transmitted without any error as compared with audio (voice) data.

Therefore, in the GPRS, a Logical Link Control (LLC) procedure is used to transmit the packet data. Here, the LLC refers to a layer for performing data transmissions between a Mobile Station (MS) and a Serving GPRS Support Node (SGSN). The LLC performs an LLC procedure in an acknowledged data mode or an unacknowledged data mode.

FIG. 1 illustrates a construction of a typical GPRS network.

Referring to FIG. 1, the GPRS network includes a terminal (i.e., MS: Mobile Station) 10, a base station 20, a Serving GPRS Support Node (SGSN) 30, and a public network 40.

The SGSN 30 supports packet transmissions heading to the base station 20, and is connected to other packet switching networks such as an Internet network, or the like.

The terminal 10 and the SGSN 30 must respectively include an LLC procedure execution unit (not shown) for processing data transmissions and data receptions. The LLC procedure performed by the LLC procedure execution unit is operated differently according to two modes, namely, an acknowledged data transmission mode or an unacknowledged data transmission mode.

For instance, in the acknowledged data transmission mode, the LLC procedure execution unit of the terminal 10 transmits a numbered information frame (I-frame), while the LLC procedure execution unit of the SGSN 30 transmits an acknowledge (ack) signal for the l-frame so as to ensure reliability of data transmissions. The LLC procedure execution unit of the terminal 10 also retransmits the numbered information frame (I-frame) when the ack signal is not received from the SGSN 30 within a particular time.

Conversely, in the unacknowledged data transmission mode, the LLC procedure execution unit of the terminal 10 transmits an unconfirmed information frame (I-frame), while the LLC procedure execution unit of the SGSN 30 does not transmit the ack signal for the l-frame.

FIG. 2 illustrates an exemplary LLC procedure of the acknowledged data transmission mode at the time of receiving data.

As illustrated in the drawing, in the acknowledged data transmission mode, the LLC procedure execution unit receives packets A, B, and C and transmits the packets A, B and C as they are received. Afterwards, when the next packet E is received, an existence of a missed packet D allows the LLC procedure execution unit to operate a timer. If the packet D is received before the timer expires, both the packets D and E are all transmitted. If the packet D is not received until the timer expires, the LLC procedure execution unit transmits only the packet E.

Accordingly, in the LLC procedure of the conventional acknowledged data transmission mode, when a packet is lost or distorted over the air interface, transmission delays may occur, and this delay may be as long as a set time of the timer.

Hereafter, a packet data flow among the terminal 10, the base station 20 and the SGSN 20 will now be explained.

The terminal 10 forms one Packet Data Protocol (PDP) to prepare data transmission depending on a PDP activation between the terminal 10 and the base station 20. The terminal 10 then negotiates with a system to determine either the acknowledged data transmission mode or the unacknowledged data transmission mode.

Once determining the transmission mode, the terminal 10 executes a Frame Check Sequence (FCS) monitoring so as to check whether an error has occurred in the received data by the system. If the error has not occurred, the terminal 10 adds a frame number to the corresponding data, to thereafter transmits the data to the SGSN 30 via the base station 20.

The SGSN 30, as illustrated in FIG. 2, performs the LLC procedure using the received frame number. If the determined transmission mode is the acknowledged data transmission mode and there are no problems in the transmission sequence, the SGSN 30 transmits an Ack signal to the terminal 10 so as to guarantee the reliability of the data transmission.

Accordingly, the terminal 10 having received the Ack signal transmits data of the next sequence. Thereafter, when the data transmissions are all completed, the terminal 10 releases the PDP activation.

As aforementioned, the packet data service using the GPRS network uses the LLC procedure in order to transmit and receive data correctly without any errors over the air interface. Data related to voice chatting or real-time video (moving pictures) can be transmitted when using the LLC procedure. However, when an error has occurred or data has not been received due to problems in the air interface, additional reception requires some time to be performed, namely, the amount of time equaling the set time of the timer, and accordingly the data transmission may be aborted from time to time during transmission.

### BRIEF DESCRIPTION OF THE INVENTION

Therefore, an object of the present invention is to provide an apparatus and method for receiving LLC packet data of a mobile communications system capable of rapidly transmitting even distorted data when real-time data is required rather than correct data.

Another object of the present invention is to provide an LLC procedure of an amended acknowledged data transmission mode capable of ensuring real-time transmissions even if errors or data loss may occur over the air interface.

To achieve these and other advantages and in accordance with the purpose of the present invention, as embodied and broadly described herein, there is provided an apparatus for receiving LLC packet data of a mobile communications system comprising: a Serving GPRS Support Node (SGSN) to set a session by analyzing a call connection request signal and to process an LLC-processed packet data; a base station to connect to the SGSN and thus receive packet data which a terminal transmits in the session; and a public network to set a packet data transmission path by connecting to another communications network under the control of the SGSN.

Preferably, the SGSN may include: a controller to perform a setting and releasing of a session for a packet data transmission, LLC processing, and Frame Check Sequence (FCS) checking; a Packet Data Protocol (PDP) unit to connect to the controller, and to set and release a session for the packet data transmission; an LLC unit to control a transmission speed of a frame unit packet data under the control of the controller; a FCS unit to check an error of the frame data under the control of the controller so as to correct the error, and to check and output the error occurrence; a memory unit to record, store, and output various operation systems and data; and a multimedia unit to input/output signals of such voice, image, and character by being connected to the controller, and to input dialing signals and control commands.

According to the present invention, a method for receiving LLC packet data of a mobile communications system may include: detecting missed data using a frame number of received data; checking whether the number of the missed data having detected is less than a reference value; and ignoring the corresponding missed data and rather transmitting currently-received data in real-time.

Preferably, the received data can be data requiring a real-time transmission such as voice chatting or real-time video (moving pictures).

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a construction of a typical GPRS network;

FIG. 2 illustrates an LLC procedure of an acknowledged data transmission mode at the time of receiving data;

FIG. 3 illustrates an exemplary construction of an apparatus for receiving LLC packet data of a mobile communications system according to the present invention;

FIG. 4 illustrates an exemplary detailed construction of a mobile switching center (i.e., SGSN: Serving GPRS Support Node) shown in FIG. 3;

FIG. 5 illustrates a first embodiment of an exemplary method for receiving LLC packet data of a mobile communications system according to the present invention; and

FIG. 6 illustrates a second embodiment of an exemplary method for receiving LLC packet data of a mobile communications system according to the present invention.

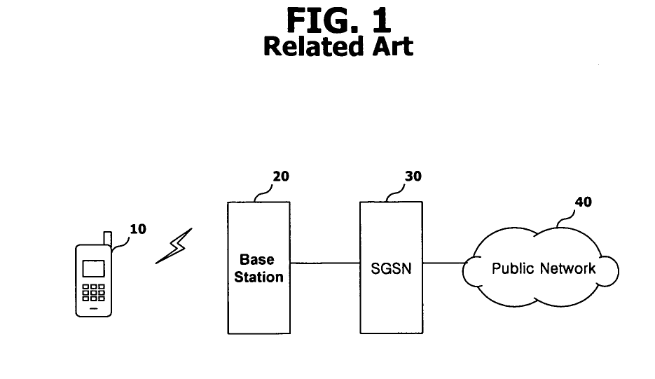

### DETAILED DESCRIPTION OF THE INVENTION

Reference will now be made in detail to the preferred embodiments of the present invention, examples of which are illustrated in the accompanying drawings.

Data transmissions between an SGSN and a terminal must be performed rapidly and correctly for wireless communications, such as a wireless Internet service, and an LLC procedure is used to correctly transmit and receive data. However, data related to voice chatting or real-time videos (moving pictures) can be transmitted with minimal data errors, but the use of the LLC procedure causes undesirable delays.

Therefore, the present invention proposes a data transmission method which is more effective when real-time data transmissions are preferred over data transmissions with minimal errors, namely, when data transmissions need to be performed immediately despite some errors.

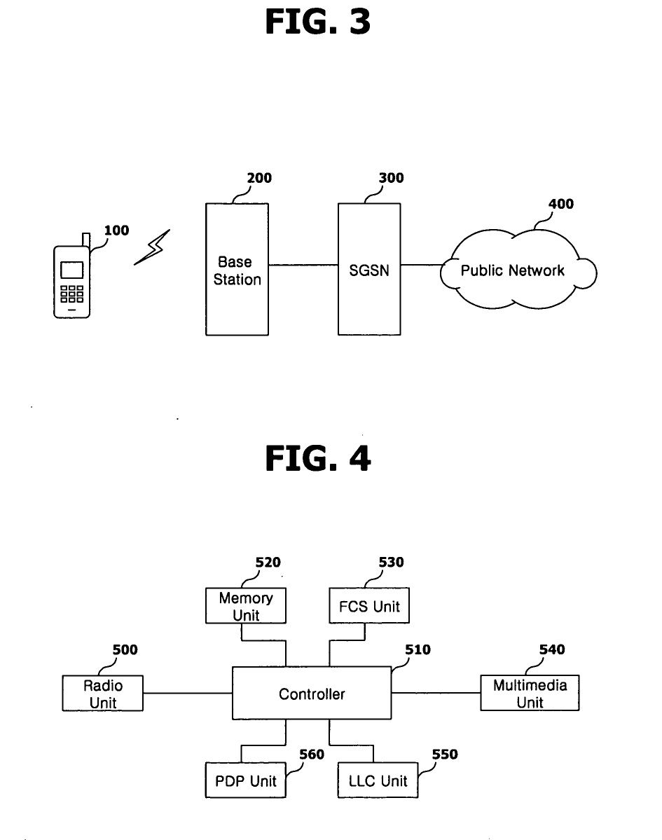

FIG. 3 illustrates an exemplary construction of an apparatus for receiving LLC packet data of a mobile communications system according to the present invention.

As illustrated in FIG. 3, the apparatus for receiving LLC packet data of a mobile communications system according to the present invention may include: a Serving GPRS Support Node (SGSN) 300; a base station 200 to connect to the SGSN 300 and thus receive packet data which a terminal 100 transmits in the set session; and a public network 400 which connects to another mobile communications system, a radio communications network, a wired communications network and an Internet network under the control of the SGSN 300, and thus sets a packet data transmission path.

The SGSN 300, as shown in FIG. 4, may include: a controller 510 to monitor an overall operation of the mobile communications system, and to perform a setting/releasing of a session for the packet data transmission, a Logical Link Control (LLC) processing and a Frame Check Sequence (FCS) checking; a Packet Data Protocol (PDP) unit 560 to set a session for the packet data and release the session when the packet data has completely transmitted; a LLC unit 550 to improve a transmission speed for frame unit packet data in a state that reliability is ensured under the control of the controller 510; a FCS unit to perform checking and correcting of frame data error under the control of the controller 510; a memory unit 520 to record, store and output an operation program and data; and a multimedia unit 540 to input/output audio signals, image signals and character signals, and to input dialing signals and control commands.

The FCS unit 530 of the SGSN 300 monitors a radio transmission error of the packet data applied as a frame unit under the control of the controller 510. If the error can be corrected, the FCS unit 530 corrects the error, while outputting an error occurrence signal if the error can not be corrected.

When a particular range of error occurs in the packet data applied as a frame unit under the control of the controller 510, the LLC unit 550 of the SGSN 300 permits the error occurrence, and receives a frame of the next sequence. On the other hand, when an error having a range greater than the particular range occurs, the LLC unit 550 requests a retransmission of the error occurred frame within the set time range in an LLC checking mode.

The PDP unit 560 of the SGSN 300 sets a session for the packet data transmission between the terminal 100 and the SGSN 300 under the control of the controller 510, and releases the session when the packet data communication is completed.

The controller 510 of the SGSN 300 controls the base station 200 to receive the packet data transmitted from the terminal 100, and controls the PDP unit 560 to set a session. The controller 510 also controls the FCS unit 530 to check whether frame unit data contains an error which cannot be corrected. When the error occurs as a particular frame unit, the controller 510 controls the LLC unit 550 to permit the error occurrence. When the error occurrence exceeds the permitted range, the controller 510 allocates a particular time by each frame unit depending on an acknowledged data transmission mode to request a retransmission.

Hereinafter, an exemplary operation of the apparatus for transmitting and receiving the LLC packet data of the mobile communications system having such construction will now be explained with reference to the accompanying drawing.

A session for transmitting packet data must be set between the terminal 100 and the SGSN 300 so that the terminal can transmit the packet data. The session can be set as follows. The terminal 100 requests the packet data transmission, and such requesting is applied to the SGSN 300 via the base station 200. The SGSN 300 then controls its PDP unit 560 to set the corresponding session.

Once the session is set between the terminal 100 and the SGSN 300, the SGSN 300 receives the packet data transmitted by the terminal 100 via the base station 200.

The SGSN 300 applies the received packet data to the FCS unit 530 to determine whether a transmission error is contained in the frame unit data. If it is determined that the transmission error has occurred, the FCS unit 530 corrects the error and outputs the data if the FCS unit 530 itself can correct the data error, while outputting a frame unit error occurrence signal if the self-correction is possible for the data error.

The controller 510 sequentially assigns the frame unit packet data outputted by the FCS unit 530 based on sequence numbers recorded in their header parts to thusly record and store the packet data in an allocated area.

When each frame of the assigned packet data is all received according to a corresponding format unit without any error, the controller 510 completes the reception. The format or file unit is constructed with a plurality of packet data frames. Such format, for example, may include video files, MP3 files, voice chatting files, or the like.

However, the assigned frames are not arranged in sequence and because errors that occur may cause some data to be lost, the controller 510 controls the LLC unit 550 to determine whether the error has a size smaller than a particular set size.

That is, even if the transmission error causes a sequential loss of frames (up to two frames), if there would be no significant problems in correcting the packet data of the format unit or file unit, the LLC unit 550 can permit up to two error occurrences. Such error occurrence within the permitted range can be checked by the LLC unit 550. The permitted range checked by the LLC unit 550 can be randomly varied or specifically modified by a user.

For example, contents of video signals (VIDEO), music signals (MP3), voice chatting signals, or the like can easily be confirmed even if the transmission error partially occurs in the frame unit data.

However, when a frame error having a size greater than the permitted size occurs in the received packet data, the LLC unit 550 applies the acknowledged data mode of the LLC procedure, and accordingly requests the retransmission for the error-occurred frame for a set time and again receives the corresponding frame to correct the error with delay for a time corresponding to the set time.

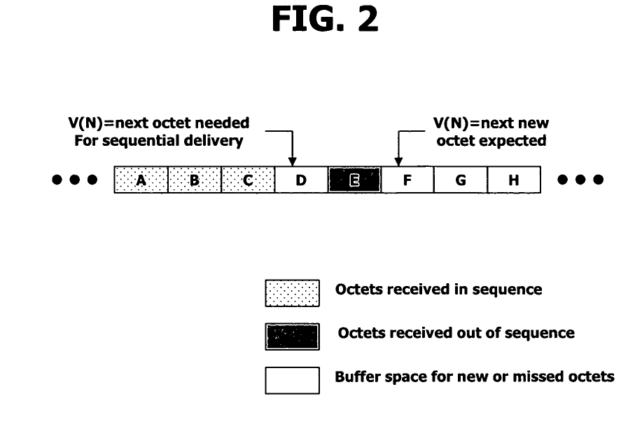

Let us assume that the format unit packet data in FIG. 2, contain frames A through H, whereby the frames A to C are received through the set radio session, and the frame E is received in a state that the frame D containing an error has not been received.

In this case, if the LLC unit 550 permits less than one erroneous frame, the LLC unit 550 allocates the particular time having set to request the retransmission for the corresponding frame. That is, the SGSN 300 requests the terminal 100 for the retransmission of the frame D and waits for the retransmission during the particular set time period. If the frame D is retransmitted within the set time to thusly be normally received, the SGSN 300 checks a frame to be received in the next sequence. If the frame has not been retransmitted within the set time or an error occurs again after being retransmitted, the SGSN 300 gives up the reception of the frame (i.e., no longer waits for frame reception).

If the LLC unit 550 permits up to two erroneous frames, the LLC unit 550 gives up the reception of the frame D, and checks a normal reception after a frame F which is expected to be received in the next sequence, so that the range of the erroneous frame permitted by a control value of the LLC unit 550 is determined.

Accordingly, in the present invention, the frame error within the range permitted by the LLC unit 550 can be ignored and a delay is not generated for the time taken by requesting the retransmission of the corresponding frame and waiting for the retransmission thereof. As a result, the time for receiving the overall packet data can be reduced. Also, the retransmission for the erroneous frame having a range greater than the permitted range is requested according to the conventional LLC acknowledged data mode, and thus the reliability of packet data transmissions can be ensured.

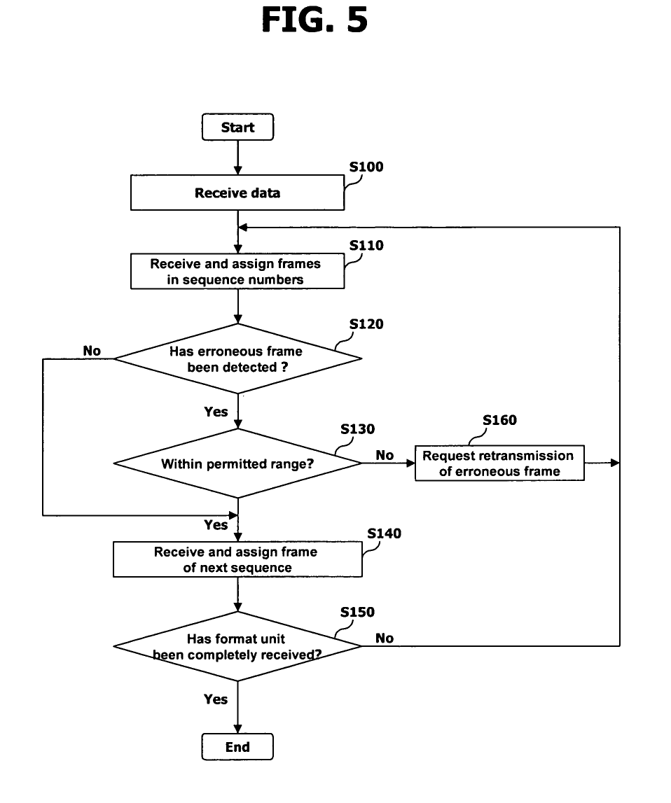

Hereinafter, a first embodiment for an exemplary method for receiving LLC packet data of a mobile communications system according to the present invention will now be explained with reference to FIG. 5.

First, the controller 510 of the SGSN 300 controls the PDP unit 560 to set a session, and receives packet data through the set session of a radio unit 500 to thereafter record and assign the received packet data to the allocated area according to their sequential numbers (S110).

The controller 510 controls the FCS unit 530 to check whether a transmission error has occurred in the data of each frame having received and assigned (S120). If a transmission error has occurred, the controller 510 determines whether the range of the corresponding transmission error is within the set permitted range (S130).

If it is determined that the occurred transmission error exceeds the set permitted range, the LLC unit 550 requests retransmission of the erroneous frame for the set particular time in the acknowledged data mode (S160). The LLC unit 550 re-performs the steps of receiving and assigning the frame and the checking of the error occurrence by returning to the step S110.

Conversely, if it is determined that the range of the occurred transmission error is within the permitted set range, the controller 510 ignores the detected error, and receives and assigns the packet data frame of the next sequence (S140). The controller 510 then determines whether every frame of the corresponding format unit or file unit constructing the received packet data has been completely received (S150). If it is determined that every frame has not been completely received, the controller 510 returns to the reception step (S110), to thusly re-perform the receiving and assigning of the packet data and the confirming of the error occurrence. If all frames have been received according to the determination (S150), the controller 510 terminates all steps.

The method for receiving the LLC packet data of the terminal 100 and the SGSN 300 in the mobile communications system according to the present invention can be applied in an identical manner, thus a detailed explanation thereof will be omitted.

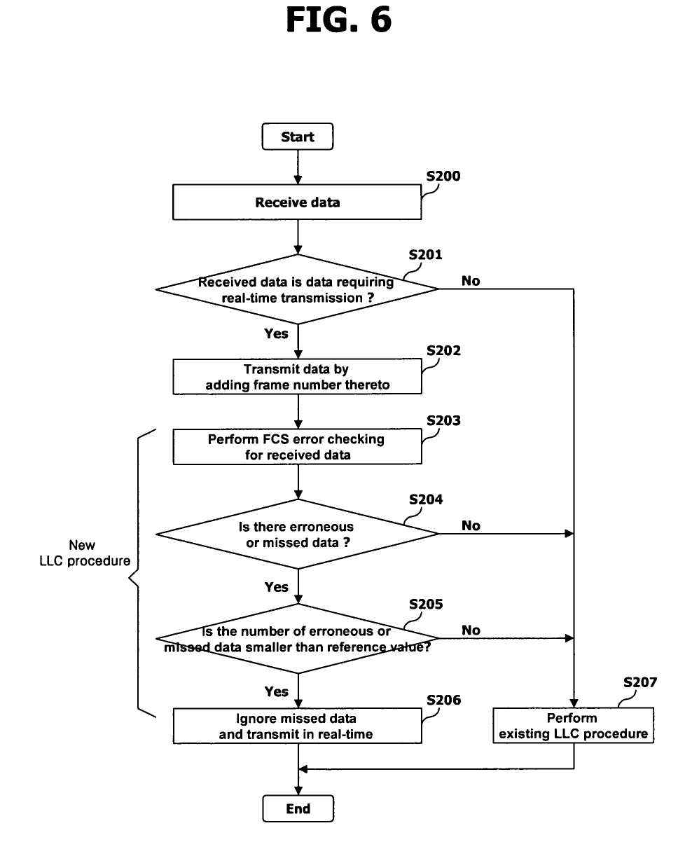

FIG. 6 illustrates a second embodiment for an exemplary method for receiving LLC packet data of a mobile communications system according to the present invention.

Referring to FIG. 6, upon receiving data (packets) via the base station 200, the terminal 100 checks whether the received data requires real-time transmission (S200 and S201). At this time, the data requiring the real-time transmission can be related to voice chatting or real-time videos (moving pictures).

If the received data does not require real-time transmission, the terminal 100 performs the existing LLC procedure to process the data (S207), while adding a frame number to the data and unconditionally transmitting the corresponding data to the SGSN 300 if the received data requires real-time transmission (S202).

The SGSN 300 uses the received frame number to performs a FCS error checking for the received data, and thus checks whether there exists data containing an error or missed (lost) data (S204 and S205). The FCS error checking is previously set by a user as a part for determining whether to quickly transmit even erroneous (distorted) data or to give up the transmission of the erroneous (distorted) data.

If erroneous or missed data exists, the SGSN 300 checks whether the number of erroneous or missed data is smaller than a reference value (S205). If the number of the erroneous or missed data is smaller than the reference value, the erroneous or missed data is ignored and the currently-received data is transmitted (S206).

Conversely, if the erroneous or missed data does not exist or the number of the erroneous or missed data is greater than the reference value in the step S205, which means there is a large amount of data has not been received, the SGSN 300 uses the existing LLC procedure to re-receive the corresponding data.

For instance, in an improved LLC procedure of the acknowledged data transmission mode, the LLC procedure execution unit of the SGSN 300 receives packets A, B and C and transmits the packets A, B and C as they are received. Afterwards, upon receiving the next packet E, the LLC procedure execution unit uses a sequence number of a packet header to recognize the number of missed octets. When the number of missed octets is greater than a reference value, the LLC procedure execution unit re-receives the missed octets. If the number of missed octets is smaller than the reference value, the LLC procedure execution unit transmits the data (packet E). As a result, in the present invention, if the number of missed data is relatively small (i.e., the size of the packet D is small), the LLC procedure execution unit ignores the missed data (packet D) and transmits the packets A, B, C and E to allow real-time transmission to be achieved.

As aforementioned, in the present invention, the error permitted-range is set in the LLC unit and the transmission error within the permitted range is ignored, and accordingly the reception time can be shortened. The erroneous data exceeding the permitted range is required for retransmission according to the LLC acknowledged data transmission mode, so as to enable an improvement of reliability of the received data.

Furthermore, in the present invention, since the permitted range inputted in the LLC unit can be easily set, it may be convenient used to selectively control the reception time and reliability corresponding to usage.

Also, in the present invention, the acknowledged data transmission LLC procedure designed to transmit and receive correct data without errors (or with minimal errors) over the air interface is complemented. As a result, even if audio or real-time data partially contains some errors and is lost over the air interface, real-time transmissions are ensured to allow the user to enjoy voice chatting or real-time videos (moving pictures) more conveniently.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for receiving Logical Link Control packet data of a mobile communications system comprising:
a Packet Data Protocol unit to set and release a session for a radio packet data communication;
a controller to perform overall controlling operations of a system;
a Logical Link Control unit to control a transmission speed of a frame unit packet data under the control of the controller; and
a Frame Check Sequence unit to monitor an error of the frame data under the control of the controller, and to confirm and output an error occurrence.

2. The apparatus of claim 1, wherein the Frame Check Sequence unit monitors the error of the packet data applied as a frame unit under the control of the controller, and corrects the error when the error can be corrected, while outputting a frame error occurrence signal when the error can not be corrected.

3. The apparatus of claim 1, wherein the Logical Link Control unit permits the error occurrence and receives a frame of the next sequence when the error having a particular range occurs in the packet data applied as the frame unit under the control of the controller, and when an error having a range greater than the particular range occurs, the Logical Link Control unit requests a retransmission of the error-occurred frame and receives the frame in a Logical Link Control acknowledged data transmission mode within the set time range.

4. The apparatus of claim 1, wherein the Packet Data Protocol unit sets and releases the session for the radio packet data transmission between a terminal and a Serving GPRS Support Node under the control of the controller.

5. An apparatus for receiving a Logical Link Control packet data of a mobile communications system comprising:
a Serving GPRS Support Node to set a session by analyzing a call connection request signal, and to process a Logical Link Control processed packet data;
a base station to connect to the Serving GPRS Support Node and thus receive packet data transmitted from a terminal in the set session; and
a public network to connect to another communications network under the control of the Serving GPRS Support Node and thus to set a packet data transmission path.

6. The apparatus of claim 5, wherein the Serving GPRS Support Node includes:
a controller to control an overall operation of the system, and to perform a setting and releasing of the session for a packet data communication of a packet switching method, a Logical Link Control processing, and a Frame Check Sequence checking;
a Packet Data Protocol unit to connect to the controller and thus to set and release the session for the packet data communication;
a Logical Link Control unit to control a transmission speed of a frame unit packet data under the control of the controller;
a Frame Check Sequence unit to monitor and correct an error of the frame data under the control of the controller, and to confirm and output an error occurrence;
a memory unit to record, store, and output various operation systems and data; and
a multimedia unit to connect to the controller, to input/output audio signals, image signals, and character signals, and to input dialing signals and control commands.

7. The apparatus of claim 6, wherein the Frame Check Sequence unit monitors the error of the packet data applied as a frame unit under the control of the controller, and corrects the error when the error can be corrected, while outputting a frame error occurrence signal when the error can not be corrected.

8. The apparatus of claim 6, wherein the Logical Link Control unit permits the error occurrence and receives a frame of the next sequence when the error having a particular range occurs in the packet data applied as the frame unit under the control of the controller, and when an error having a range greater than the particular range occurs, the Logical Link Control unit requests a retransmission of the error-occurred frame and receives the frame in a Logical Link Control acknowledged data transmission mode within a set time range.

9. The apparatus of claim 6, wherein the Packet Data Protocol unit sets and releases the session for the radio packet data transmission between a terminal and a Serving GPRS Support Node under the control of the controller.

10. A method for receiving Logical Link Control packet data of a mobile communications system comprising:
a reception step of, for receiving packet data through a particular session, receiving and assigning frame unit packet data according to their sequence numbers;
an error determination step of, when the frame unit packet data having received in the step contains an error, determining whether the error has a range less than a permitted range; and
a format step of, when it is determined in the above step the range of the error is within the permitted range, repeatedly receiving and assigning frame unit packet data of the next sequence until every format unit frames are received.

11. The method of claim 10, further comprising a Logical Link Control step of, when the range of the error having occurred in the error determination step is greater than the permitted range, requesting a retransmission of the erroneous frame in a Logical Link Control acknowledged data transmission mode for a set time, and receiving the retransmitted frame according to the request.

12. The method of claim 11, wherein the reception step comprises:
determining whether to receive the frame unit packet data through the set session; and
receiving and assigning the packet data according to each sequence number of the frames when it is determined to receive the packet data in the step.

13. The method of claim 11, wherein the error determination step comprises:
determining whether there is an error-occurred frame by performing a Frame Check Sequence checking for each frame of the packet data having received and assigned in the reception step; and
determining whether the error has a range less than the permitted range when it is determined that there is the error-occurred frame in the step.

14. The method of claim 11, wherein the format step comprises:
when the range of the error-occurred frame is within the permitted range in the error determination step, ignoring the error-occurred frame, and rather receiving and assigning packet data by the next frame; and
determining whether the frame unit packet data having received in the step is the last format unit frame, providing feedback to the reception step if the format unit frame has not been completely received, and terminating the entire process if the format unit frame has been completely received.

15. A method for receiving Logical Link Control of a mobile communications system comprising:
detecting missed data using a frame number of received data;
checking whether the number of the missed data having detected is less than a reference value; and
ignoring the corresponding missed data when the number of the missed data is less than the reference value, and transmitting currently-received data in real-time.

16. The method of claim 15, wherein the number of missed data is recognized using a packet data header.

17. The method of claim 15, wherein the received data is data requiring a real-time transmission.

18. The method of claim 17, wherein the data requiring the real-time transmission is data of voice chatting or real-time videos.

19. The method of claim 16, further comprising re-receiving the missed data when the number of the missed data is greater than the reference value.
